(19) United States
(12) Patent Application Publication
(10) Pub. No.: US 2025/0175731 A1
(43) Pub. Date: May 29, 2025

(54) MODULAR SHELL-REPLACEMENT EARPHONE

(71) Applicant: Cosonic Intelligent Technologies Co., Ltd., Dongguan (CN)

(72) Inventors: Dengxu CAO, Dongguan (CN); Xudong XUE, Dongguan (CN); Xujian LUO, Dongguan (CN)

(21) Appl. No.: 18/818,592

(22) Filed: Aug. 29, 2024

(30) Foreign Application Priority Data
Nov. 28, 2023 (CN) 202311603359.3

(51) Int. Cl. H04R 1/10

(52) U.S. Cl. CPC H04R 1/1066; H04R 1/1041; H04R 1/105; H04R 1/1075

(57) ABSTRACT

A modular shell-replacement earphone is provided, which includes: an in-ear earphone defining a first mounting cavity; a half-in-ear earphone shell, defining a second mounting cavity; an open earphone shell, defining a third mounting cavity; and an earphone main module. An end of the earphone main module is detachably mounted in the first mounting cavity, the second mounting cavity, or the third mounting cavity. The modular shell-replacement earphone can be replaced to different types of earphones such as an in-ear earphone, a half-in-ear earphone and an open-ear earphone through a replaceable shell. The modular shell-replacement earphone adopts a modular structure, which is easy to maintain and repair. The modular shell-replacement earphone changes a traditional earphone production method, and derives multiple products through one module, which effectively shortens a research and development cycle, reduces production costs, and produces as many products as possible with as little input as possible.

### CROSS-REFERENCE TO RELATED APPLICATION

This application claims priority to Chinese Patent Application No. 202311603359.3, filed on Nov. 28, 2023, which is herein incorporated by reference in its entirety.

### TECHNICAL FIELD

The disclosure relates to the technical field of earphones, and more particularly to a modular shell-replacement earphone.

### BACKGROUND

With the booming development of the smart wearable industry, earphones are becoming more diverse and professional. China Business Industry Research Institute predicts that a sales volume of the earphones will reach more than 3 billion pairs in 2023. How to meet needs of users in different scenarios and appearances and give users a better experience is one of the keys to product success.

There are three main categories of true wireless stereo (TWS) earphones on the market: in-car TWS earphones, half-in-ear TWS earphones, and open car clips/ear hooks, which correspond to different detailed scenarios, and the above TWS earphones each have own advantages and disadvantages, but none of them can meet all the needs of users. For example: the in-car TWS earphones have good sound effects, stable wearing, and outstanding noise reduction effects, but they have the disadvantages of being uncomfortable and unhygienic to wear. Although the half-in-car TWS earphones are obviously better than the in-ear TWS earphones in terms of wearing comfort, their noise reduction effect is much worse than that of the in-car TWS earphones. Secondly, since the half-in-ear TWS earphones have no ear caps, they all rely on a front cavity of the earphones to adapt to a human car and cannot be adjusted, and the wearing experience of different people varies greatly. The open ear clips/ear hooks have the best wearing comfort, but have no advantages compared to the other two in other aspects, and are large and not portable, and their appearance is difficult to accept, thus they are rarely used in life scenarios other than sports.

In summary, different types of the earphones have different focuses for different usage scenarios, but none of them can cover all the user's usage scenarios and lifestyles. In order to meet needs, many users need to buy 2 to 3 different types of earphones, which increases additional economic expenditures. More users only use earphones in the scenarios targeted by the product, and do not use them or forcibly endure them at other times, which leads to a decrease in user dependence on the product or a poor user experience. In addition, structural components of different types of the earphones are difficult to disassemble, which is not convenient for maintenance and repair. The structural components of different types of the earphones are difficult to share with each other, and need to be developed and produced separately, with high production costs and low production efficiency.

### SUMMARY

A technical problem to be solved of the disclosure is to provide a modular shell-replacement earphone according to disadvantages of the above related art. The modular shell-replacement earphone can be replaced to different types of earphones such as an in-car earphone, a half-in-car earphone and an open-car earphone through a replaceable shell, so that a product suitable for various scenarios such as travel, office, and sports in a more economical way is provided, thereby better meeting diverse needs of users. The modular shell-replacement earphone can provide shells with rich shapes and colors, so that the users have a wider range of choices, and personalized needs of the users are better met. The users can choose shells of different sizes and forms to make the earphone better fit different car cavity structures and be more comfortable and stable to wear. The modular shell-replacement earphone adopts a modular structure, and the modular structure is easy to maintain and repair. The modular shell-replacement earphone changes a traditional earphone production method, and derives multiple products through one module, which effectively shortens a research and development cycle, reduces production costs, and produces as many products as possible with as little input as possible.

In order to solve the above technical problem, the technical solutions of the disclosure are as follows.

A modular shell-replacement earphone is provided, including: an in-car earphone shell, a half-in-car earphone shell, an open earphone shell and an earphone main module. The in-car earphone shell defines a first mounting cavity. The half-in-ear earphone shell defines a second mounting cavity. The open earphone shell defines a third mounting cavity. An end of the earphone main module is detachably mounted in the first mounting cavity, the second mounting cavity, or the third mounting cavity.

In an embodiment, the earphone main module includes a module shell and a horn. An end of the module shell is provided with an inserting part, and the inserting part defines a module sound outlet hole. The horn is disposed in the module shell, and the horn defines a sound outlet facing towards the module sound outlet hole.

In an embodiment, the earphone main module further includes: first module magnets disposed in the inserting part of the module shell, and the first module magnets surround the module sound outlet hole.

In an embodiment, the earphone main module further includes: a battery, a printed circuit board assembly (PCBA), charging needles and a second module magnet which are disposed in the module shell. The PCBA is electrically connected to the battery and the horn. The charging needles are mounted on the PCBA, an end of each charging needle penetrates through a side wall of the module shell, and the second module magnet is mounted on a side wall of the module shell proximate to the charging needles.

In an embodiment, the PCBA is further provided with touch keys, an indicator lamp, a microphone and a sound tube thereon. An end of each touch key is abutted against the module shell, and the indicator lamp is configured to emit light to be guided to the module shell. The module shell defines a sound pickup hole, and the sound tube is disposed between the sound pickup hole and the microphone.

In an embodiment, an end of the in-ear earphone shell defines the first mounting cavity, and the inserting part of the module shell is detachably mounted in the first mounting cavity. A bottom of the first mounting cavity defines a first sound hole corresponding to the module sound outlet hole, the other end of the in-ear earphone shell is provided with a sound outlet car cap, and the sound outlet car cap is in communication with the first sound hole of the first mounting cavity. The in-car earphone shell is provided with a first magnet mounting position, and the first magnet mounting position is located at an outer side of the bottom of the first mounting cavity. the first magnet mounting position is provided with a first shell magnet thereon, and the first shell magnet is magnetically coupled with the first module magnets.

In an embodiment, an end of the half-in-car earphone shell defines the second mounting cavity, and the inserting part of the module shell is detachably mounted in the second mounting cavity. A bottom of the second mounting cavity defines a second sound hole corresponding to the module sound outlet hole, the other end of the half-in-ear earphone shell defines a sound outlet, and the sound outlet is in communication with the second sound hole of the second mounting cavity. The half-in-ear earphone shell is provided with a second magnet mounting position, and the second magnet mounting position is located at an outer side of the bottom of the second mounting cavity. The second magnet mounting position is provided with a second shell magnet, and the second shell magnet is magnetically coupled with the first module magnets.

In an embodiment, the third mounting cavity of the open earphone shell includes: a shell covering cavity part and an inserting part positioning cavity part. A side end of the module shell is detachably mounted in the shell covering cavity part, the inserting part of the module shell is detachably mounted in the inserting part positioning cavity part, and a side of the inserting part positioning cavity part defines a third sound hole corresponding to the module sound outlet hole. A side wall of the shell covering cavity part is provided with a third magnet mounting position, the third magnet mounting position is provided with a third shell magnet, and the third shell magnet is magnetically coupled with the second module magnet.

In an embodiment, the in-car earphone shell is a hard rubber shell, a soft rubber shell, or a shell with a soft rubber material mounted on a hard rubber skeleton. The half-in-car earphone shell is a hard rubber shell, a soft rubber shell, or a shell with a soft rubber material mounted on a hard rubber skeleton. The open earphone shell is a hard rubber shell, a soft rubber shell, or a shell with a soft rubber material mounted on a hard rubber skeleton. The open earphone shell is provided with an car hook thereon, and the car hook is a hard rubber car hook, or an car hook with a soft rubber material mounted on a memory steel wire.

Beneficial effects of the disclosure are as follow: the end of the earphone main module of the disclosure is detachably mounted in the first mounting cavity, the second mounting cavity, or the third mounting cavity, the earphone is an in-car earphone when the earphone main module is combined with the in-car earphone shell; the earphone is a half-in-car earphone when the earphone main module is combined with the half-in-ear earphone shell; and the earphone is an open earphone when the earphone main module is combined with the open earphone shell. The earphone can be replaced to different types of earphones such as the in-ear earphone, the half-in-car earphone and the open-car earphone through the replaceable shell, so that a product suitable for various scenarios such as travel, office, and sports in a more economical way is provided, thereby better meeting diverse needs of users. The disclosure can provide shells with rich shapes and colors, so that the users have a wider range of choices, and personalized needs of the users are better met. The users can choose shells of different sizes and forms to make the earphone better fit different car cavity structures and be more comfortable and stable to wear. The disclosure adopts the modular structure, and the modular structure is easy to maintain and repair. The disclosure changes the traditional earphone production method, and derives multiple products through one module, which effectively shortens a research and development cycle, reduces production costs, and produces as many products as possible with as little input as possible.

### BRIEF DESCRIPTION OF DRAWINGS

FIG. 1 illustrates an exploded structural diagram of a modular shell-replacement earphone according to an embodiment of the disclosure.

FIG. 2 illustrates a schematic structural diagram of an in-ear earphone combined by an earphone main module with an in-ear earphone shell according to an embodiment of the disclosure.

FIG. 3 illustrates a schematic structural diagram of a half-in-ear earphone combined by the earphone main module with a half-in-ear earphone shell according to an embodiment of the disclosure.

FIG. 4 illustrates a schematic structural diagram of an open earphone combined by the earphone main module with an open earphone shell according to an embodiment of the disclosure.

FIG. 5 illustrates a first exploded structural diagram of the earphone main module according to an embodiment of the disclosure.

FIG. 6 illustrates a second exploded structural diagram of the earphone main module according to an embodiment of the disclosure.

FIG. 7 illustrates a first exploded structural diagram of the in-ear earphone shell according to an embodiment of the disclosure.

FIG. 8 illustrates a second exploded structural diagram of the in-ear earphone shell according to an embodiment of the disclosure.

FIG. 9 illustrates a first exploded structural diagram of the half-in-ear earphone shell according to an embodiment of the disclosure.

FIG. 10 illustrates a second exploded structural diagram of the half-in-ear earphone shell according to an embodiment of the disclosure.

FIG. 11 illustrates a first exploded structural diagram of the open earphone shell according to an embodiment of the disclosure.

FIG. 12 illustrates a second exploded structural diagram of the open earphone shell according to an embodiment of the disclosure.

### DETAILED DESCRIPTION OF EMBODIMENTS

The structural principle and work principle of the disclosure are further described in detail in conjunction with drawings below.

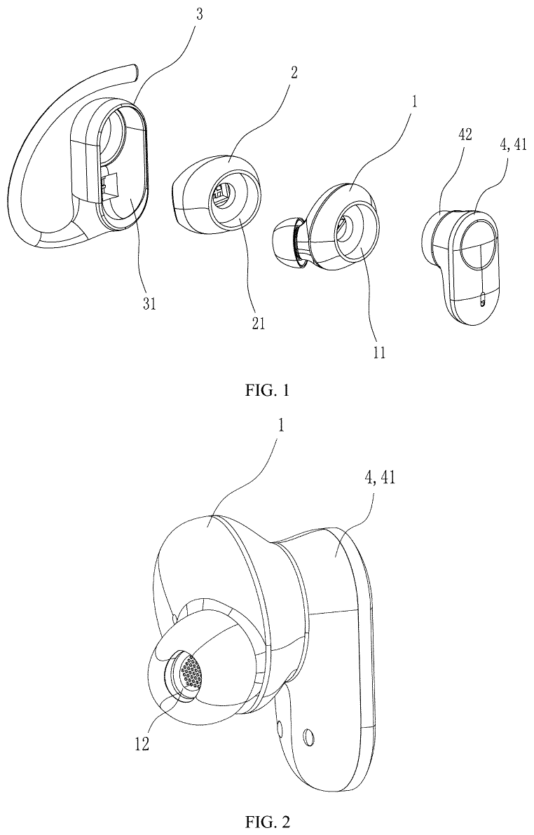

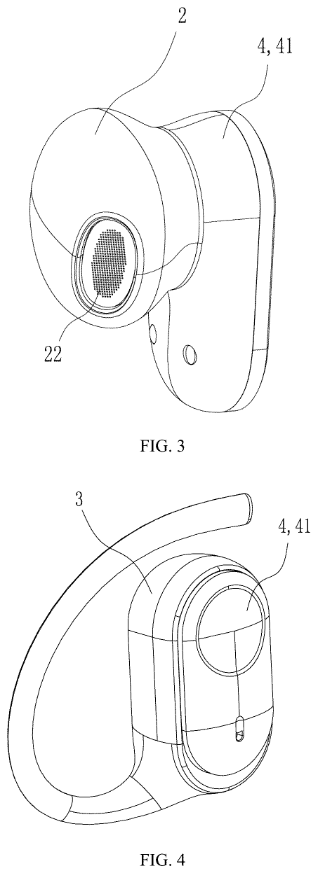

As shown in FIGS. 1-12, the disclosure provides a modular shell-replacement earphone, including: an in-car earphone shell 1, a half-in-ear earphone shell 2, an open earphone shell 3 and an earphone main module 4. The in-car earphone shell 1 defines a first mounting cavity 11. The half-in-car earphone shell 2 defines a second mounting cavity 21. The open earphone shell 3 defines a third mounting cavity 31. An end of the earphone main module 4 is detachably mounted in the first mounting cavity 11, the second mounting cavity 21, or the third mounting cavity 31. In the disclosure, the end of the earphone main module 4 is detachably mounted in the first mounting cavity 11, the second mounting cavity 21, or the third mounting cavity 31, the earphone is an in-car earphone when the earphone main module 4 is combined with the in-car earphone shell 1; the earphone is a half-in-car earphone when the earphone main module 4 is combined with the half-in-car earphone shell 2; and the earphone is an open earphone when the earphone main module 4 is combined with the open earphone shell 3. The earphone can be replaced to different types of earphones such as the in-ear earphone (as shown in FIG. 2), the half-in-car earphone (as shown in FIG. 3) and the open-ear earphone (as shown in FIG. 4) through a replaceable shell, so that a product suitable for various scenarios such as travel, office, and sports in a more economical way is provided, thereby better meeting diverse needs of users. The disclosure can provide shells with rich shapes and colors, so that the users have a wider range of choices, and personalized needs of the users are better met. The users can choose shells of different sizes and forms to make the earphone better fit different ear cavity structures and be more comfortable and stable to wear. The disclosure adopts a modular structure, and the modular structure is easy to maintain and repair. The disclosure changes the traditional earphone production method, and derives multiple products through one module, which effectively shortens a research and development cycle, reduces production costs, and produces as many products as possible with as little input as possible. The earphone main module 4 is connected to the shells through a mechanical structure, and the earphone main module 4 is locked in the shell by pressing the earphone main module 4. The earphone main module 4 is ejected from the shell by pressing the earphone main module 4 again when the earphone main module 4 is locked in the shell. It should be noted that the disclosure is not limited to adopt the in-ear earphone shell 1, the half-in-ear earphone shell 2 and the open earphone shell 3, and other forms of shells can be also adopted. The open earphone shell 3 can be an car-hanging earphone shell, a rear-mounted earphone shell, or an ear-clip earphone shell.

As shown in FIGS. 1-6, the earphone main module 4 includes a module shell 41, a horn 45 and first module magnets 43. An end of the module shell 41 is provided with an inserting part 42, and the inserting part 42 defines a module sound outlet hole 421. The horn 45 is disposed in the module shell 41, and the horn 45 defines a sound outlet facing towards the module sound outlet hole 421. The first module magnets 43 are disposed in the inserting part 42 of the module shell 41, and the first module magnets 43 surround outside the module sound outlet hole 421. The first module magnets 43 are fan-shaped, and the inserting part 42 can be adsorbed in the in-ear earphone shell 1 or the half-in-car earphone shell 2 through a magnetic suction method using the first module magnets 43.

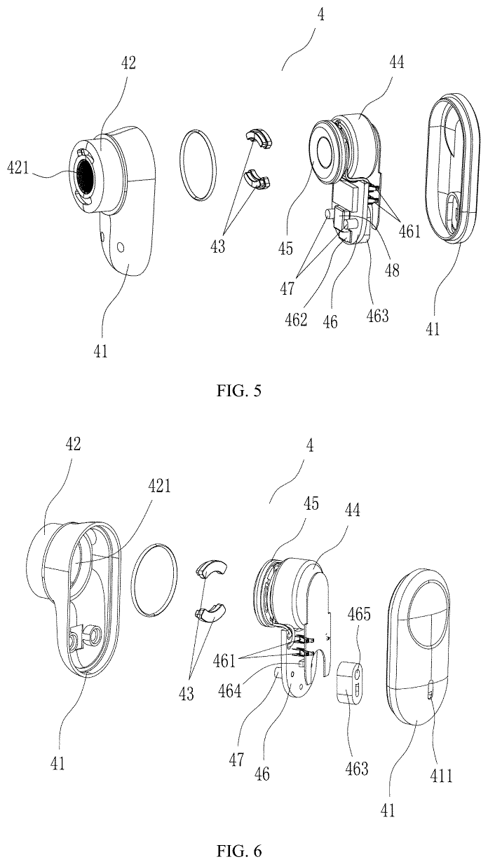

As shown in FIGS. 5-6, the earphone main module 4 further includes: a battery 44, a PCBA 46, charging needles 47 and a second module magnet 48 which are disposed in the module shell 41. The PCBA 46 is electrically connected to the battery 44 and the horn 45. The charging needles 47 are mounted on the PCBA 46, an end of each charging needle 47 penetrates through a side wall of the module shell 41, and the second module magnet 48 is mounted on a side wall of the module shell 41 proximate to the charging needles 47. The PCBA 46 is further provided with touch keys 461, an indicator lamp 464, a microphone 462 and a sound tube 463 thereon. An end of each touch key 461 is abutted against the module shell 41, and the indicator lamp 464 is configured to emit light to be guided to the module shell 41. The module shell 41 defines a sound pickup hole 411, the sound tube 463 is disposed between the sound pickup hole 411 and the microphone 462, and an upper end of the sound tube 463 defines a light hole 465 for the light emitted from the indicator lamp 464 to pass through. The disclosure integrates all hardware into the earphone main module 4, which facilitates modular assembly and disassembly with the shells. The second module magnet 48 can be used not only to absorb an earphone charging box (not shown in the drawings) during earphone charging, but also to absorb it in the open earphone shell 3.

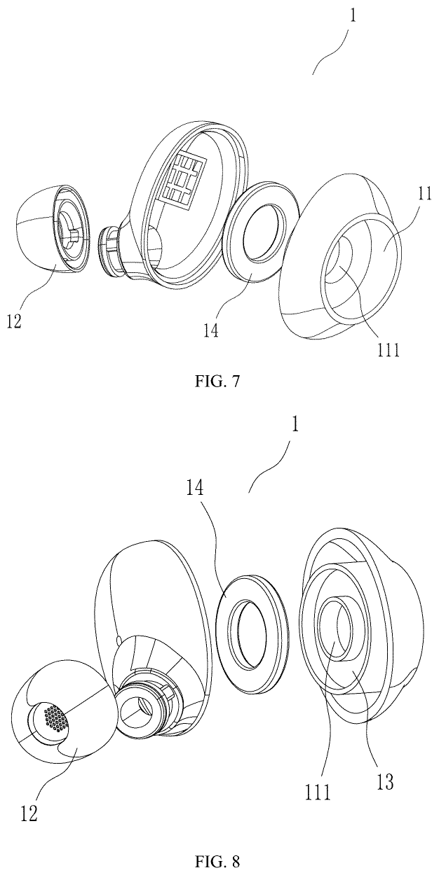

As shown in FIG. 1, FIG. 2 FIG. 7 and FIG. 8, an end of the in-car earphone shell 1 defines the first mounting cavity 11, and the inserting part 42 of the module shell 41 can be detachably mounted in the first mounting cavity 11. A bottom of the first mounting cavity 11 defines a first sound hole 111 corresponding to the module sound outlet hole 421, the other end of the in-car earphone shell 1 is provided with a sound outlet car cap 12, and the sound outlet car cap 12 is in communication with the first sound hole 111 of the first mounting cavity 11. The in-car earphone shell 1 is provided with a first magnet mounting position 13, and the first magnet mounting position 13 is located at an outer side of the bottom of the first mounting cavity 11. The first magnet mounting position 13 is provided with a first shell magnet 14, and the first shell magnet 14 is magnetically coupled with the first module magnets 43.

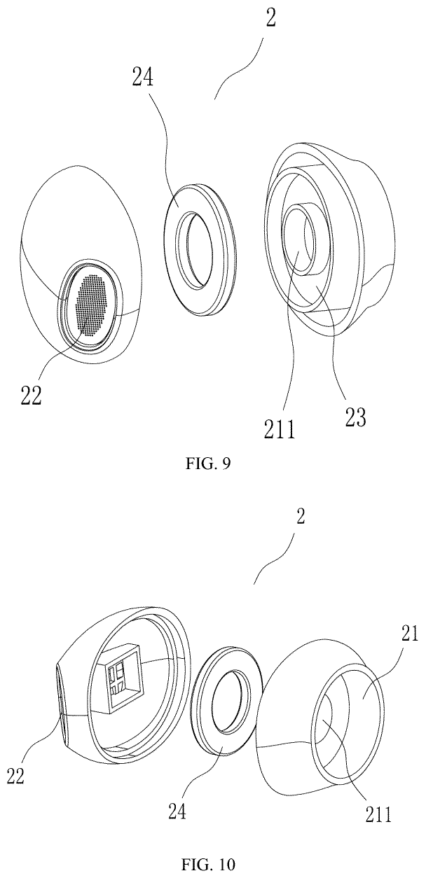

As shown in FIG. 1, FIG. 3, FIG. 9 and FIG. 10, an end of the half-in-ear earphone shell 2 defines the second mounting cavity 21, and the inserting part 42 of the module shell 41 can be detachably mounted in the second mounting cavity 21. A bottom of the second mounting cavity 21 defines a second sound hole 211 corresponding to the module sound outlet hole 421, the other end of the half-in-car earphone shell 2 defines a sound outlet 22, and the sound outlet 22 is in communication with the second sound hole 211 of the second mounting cavity 21. The half-in-car earphone shell 2 is provided with a second magnet mounting position 23, and the second magnet mounting position 23 is located at an outer side of the bottom of the second mounting cavity 21. the second magnet mounting position 23 is provided with a second shell magnet 24, and the second shell magnet 24 is magnetically coupled with the first module magnets 43.

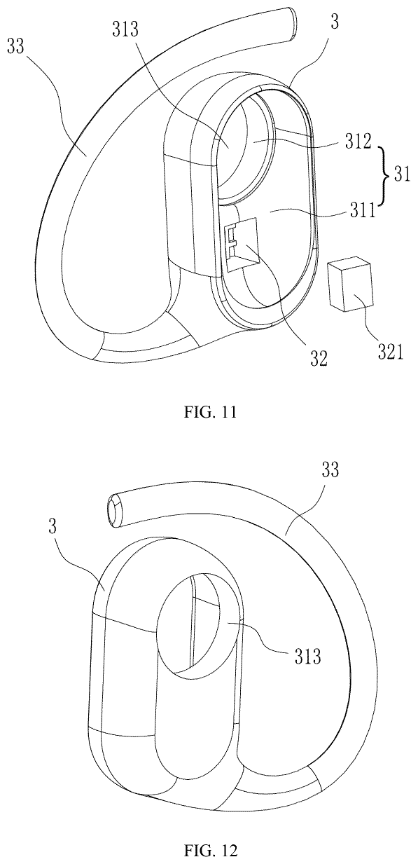

As shown in FIG. 1, FIG. 4, FIG. 11 and FIG. 12, the third mounting cavity 31 of the open earphone shell 3 includes: a shell covering cavity part 311 and an inserting part positioning cavity part 312. A side end of the module shell 41 is detachably mounted in the shell covering cavity part 311, the inserting part 42 of the module shell 41 is detachably mounted in the inserting part positioning cavity part 312, and a side of the inserting part positioning cavity part 312 defines a third sound hole 313 corresponding to the module sound outlet hole 421. A side wall of the shell covering cavity part 311 is provided with a third magnet mounting position 32, the third magnet mounting position 32 is provided with a third shell magnet 321, and the third shell magnet 321 is magnetically coupled with the second module magnet 48.

In an embodiment, the in-car earphone shell 1 is a hard rubber shell, a soft rubber shell, or a shell with a soft rubber material mounted on a hard rubber skeleton. The half-in-car earphone shell 2 is a hard rubber shell, a soft rubber shell, or a shell with a soft rubber material mounted on a hard rubber skeleton. The open earphone shell 3 is a hard rubber shell, a soft rubber shell, or a shell with a soft rubber material mounted on a hard rubber skeleton. The open earphone shell 3 is provided with an car hook 33 thereon, and the car hook 33 is a hard rubber car hook, or an car hook with a soft rubber material mounted on a memory steel wire.

The above description is merely embodiments of the disclosure. Any slight amendment. equivalent changes and amendments made to the above embodiments according to the technical solution of the disclosure are within the scope of the technical solution of the disclosure.

What is claimed is:

1. A modular shell-replacement earphone, comprising:
an in-car earphone shell, defining a first mounting cavity;
a half-in-car earphone shell, defining a second mounting cavity;
an open earphone shell, defining a third mounting cavity; and
an earphone main module, wherein an end of the earphone main module is detachably mounted in the first mounting cavity, the second mounting cavity, or the third mounting cavity.

2. The modular shell-replacement earphone as claimed in claim 1, wherein the earphone main module comprises:
a module shell, wherein an end of the module shell is provided with an inserting part, and the inserting part defines a module sound outlet hole; and
a horn, disposed in the module shell, wherein the horn defines a sound outlet facing towards the module sound outlet hole.

3. The modular shell-replacement earphone as claimed in claim 2, wherein the earphone main module further comprises: first module magnets disposed in the inserting part of the module shell, and the first module magnets surround the module sound outlet hole.

4. The modular shell-replacement earphone as claimed in claim 3, wherein the earphone main module further comprises: a battery, a printed circuit board assembly (PCBA), charging needles and a second module magnet which are disposed in the module shell, the PCBA is electrically connected to the battery and the horn, the charging needles are mounted on the PCBA, an end of each charging needle penetrates through a side wall of the module shell, and the second module magnet is mounted on a side wall of the module shell proximate to the charging needles.

5. The modular shell-replacement earphone as claimed in claim 4, wherein the PCBA is provided with touch keys, an indicator lamp, a microphone, and a sound tube thereon, an end of each touch key is abutted against the module shell, the indicator lamp is configured to emit light to be guided to the module shell, the module shell defines a sound pickup hole, and the sound tube is disposed between the sound pickup hole and the microphone.

6. The modular shell-replacement earphone as claimed in claim 3, wherein an end of the in-car earphone shell defines the first mounting cavity, the inserting part of the module shell is detachably mounted in the first mounting cavity, a bottom of the first mounting cavity defines a first sound hole corresponding to the module sound outlet hole, the other end of the in-car earphone shell is provided with a sound outlet ear cap, and the sound outlet car cap is in communication with the first sound hole of the first mounting cavity; and the in-car earphone shell is provided with a first magnet mounting position, and the first magnet mounting position is located at an outer side of the bottom of the first mounting cavity, the first magnet mounting position is provided with a first shell magnet thereon, and the first shell magnet is magnetically coupled with the first module magnets.

7. The modular shell-replacement earphone as claimed in claim 3, wherein an end of the half-in-car earphone shell defines the second mounting cavity, the inserting part of the module shell is detachably mounted in the second mounting cavity, a bottom of the second mounting cavity defines a second sound hole corresponding to the module sound outlet hole, the other end of the half-in-car earphone shell defines a sound outlet, and the sound outlet is in communication with the second sound hole of the second mounting cavity; and the half-in-ear earphone shell is provided with a second magnet mounting position, and the second magnet mounting position is located at an outer side of the bottom of the second mounting cavity, the second magnet mounting position is provided with a second shell magnet thereon, and the second shell magnet is magnetically coupled with the first module magnets.

8. The modular shell-replacement earphone as claimed in claim 4, wherein the third mounting cavity of the open earphone shell comprises: a shell covering cavity part and an inserting part positioning cavity part, a side end of the module shell is detachably mounted in the shell covering cavity part, the inserting part of the module shell is detachably mounted in the inserting part positioning cavity part, and a side of the inserting part positioning cavity part defines a third sound hole corresponding to the module sound outlet hole.

9. The modular shell-replacement earphone as claimed in claim 8, wherein a side wall of the shell covering cavity part is provided with a third magnet mounting position, the third magnet mounting position is provided with a third shell magnet thereon, and the third shell magnet is magnetically coupled with the second module magnet.

10. The modular shell-replacement earphone as claimed in claim 1, wherein the in-car earphone shell is a hard rubber shell, a soft rubber shell or a shell with a soft rubber material mounted on a hard rubber skeleton; the half-in-car earphone shell is a hard rubber shell, a soft rubber shell or a shell with a soft rubber material mounted on a hard rubber skeleton; the open earphone shell is a hard rubber shell, a soft rubber shell or a shell with a soft rubber material mounted on a hard rubber skeleton; and the open earphone shell is provided with an car hook thereon, and the car hook is a hard rubber car hook, or an car hook with a soft rubber material mounted on a memory steel wire.
